(19) United States
(12) Patent Application Publication
(10) Pub. No.: US 2002/0108098 A1
(43) Pub. Date: Aug. 8, 2002

(54) Method for correcting optical proximity effects

(76) Inventor: Masahiko Igeta, Kanagawa (JP)

Correspondence Address: Darryl G. Walker, WALKER & SAKO, LLP, Suite 235, 300 South First Street, San Jose, CA, 95113, US

(21) Appl. No.: 10/068,441

(22) Filed: Feb. 5, 2002

(30) Foreign Application Priority Data
Feb. 7, 2001 (JP) 030560/2001

(51) Int. Cl. G06F 17/50

(52) U.S. Cl. 716/21

(57) ABSTRACT

According to one embodiment, the quantity of data that is processed to generate a correction pattern for a photomask using a computer aided design (CAD) tool may be reduced over conventional approaches. After generating an original pattern, a correction pattern to account of optical proximity effects may be generated on a block unit basis, and not an entire array. Correction data for each block may take into account adjacent block pattern features.

### TECHNICAL FIELD

The present invention relates generally to photolithography for semiconductor devices, and more particularly to a method for correcting optical proximity effects generated during photolithography in the fabrication of semiconductor devices.

### BACKGROUND OF THE INVENTION

In the fabrication of semiconductor devices, such a memory devices as but one example, photolithography can be an essential step. Photolithography typically involves a transfer of a pattern from a mask to a layer, such as a photoresist layer. Such a step typically involves placing a mask over a photoresist layer and then exposing the arrangement to a source of electromagnetic radiation, such as light at a particular frequency. Ideally a photolithography step can result in an isomorphic transfer of a pattern to a photoresist layer.

As feature sizes continue to shrink, a continuing problem that may arise during photolithography can be optical proximity effects. Optical proximity effects may occur during an exposure process by interference of light portions in particular areas. When generated, optical proximity effects can cause unwanted fluctuations in the size of a resulting photoresist pattern and/or deterioration in a resulting pattern shape. Consequently, at smaller geometries it can be essentially impossible to achieve an isomorphic transfer of a pattern to a photoresist layer due to proximity effects.

As one example, due to proximity effects a pattern designed to have a width of 0.16 μm may have a resulting width of 0.18 μm to 0.14 μm according to a surrounding pattern arrangement. Alternatively, if a designed pattern is long and rectangular, the long sides of such a pattern may be excessively shortened as compared to a desired result.

Thus, an important issue in a photolithography step of a semiconductor manufacturing process can be taking measures to address optical proximity effects (optical proximity correction or “OPC”).

Various conventional methods have been presented for correction optical proximity effects.

One method is to deform a design pattern in a photomask based upon an expected deformation in a resulting pattern. Thus, while a photomask may appear deformed, a resulting pattern in a photoresist layer or the like may closely resemble a desired pattern.

In the above-described method, a rule for correcting a mask pattern is made that can obtain a desired resulting pattern. According to the rule, a mask pattern is altered manually.

The above approach can have drawbacks, however. In particular, a correction shortage may result, with some patterns not being properly corrected, or missing correction may result, and one pattern correction may interfere with another. Further, various rules may change according to conditions and/or process. Consequently, the method has not always been sufficient and/or practical in addressing optical proximity effects.

To better address optical proximity effects, a method for automatically forming a correction pattern in a computer automated design (CAD) tool, or the like, has been described in Japanese Patent Application Laid-Open No. 10-282635. According to the method of Japanese Patent Application Laid-Open No. 10-282635, by automatically correcting for proximity effects with a CAD tool, correction shortage and/or missing correction that may occur in manual approaches may be prevented. As a result, a highly accurate mask correction may be carried out. In this way, method of Japanese Patent Application Laid-Open No. 10-282635 provides certain advantages in OPC technology.

It is noted however, that the method of Japanese Patent Application Laid-Open No. 10-282635 may have some drawbacks.

A first drawback can be the relatively large amount of data that must be processed to generate a corrected mask.

Referring now to FIG. 9, an example of a correction pattern generated by a CAD tool is set forth in a top plan view. As shown in FIG. 9, a correction pattern formed by a CAD tool can include a collection of small rectangular patterns. Representing such a collection of shapes may result in a very large amount of data.

When a correction pattern is formed, proper correction may not be carried out if correction is addressed for an individual block, as the correction of one block may affect adjacent blocks. Thus, in the case of a semiconductor device having an array, it can be necessary to automatically form a correction pattern for an entire array.

Conventionally forming a pattern may include various steps. First, verified mask data for an entire array may be prepared. Next, a correction pattern may be formed for the entire array. Subsequently, a resulting correction pattern is directly applied to an array mask data.

FIG. 10 shows a correction pattern formed for an entire array. As an example, for an array of 32 megabits (e.g., a memory device array), a correction pattern 40 may be represented by about 2 gigabytes of data. Such a large amount of data may result in lower efficiency during data processing. In FIG. 10, a correction pattern is represented by a hatched portion, while original mask data is presented by a lower non-hatched portion.

A conventional method such as that described above may have another drawback. An original pattern may have to be corrected, resulting in some pattern movement. If a corrected pattern is similarly moved, the quantity of data to be processed may become impractical for many applications. Large data may have to be processed because a movement can force the entire correction pattern 40 to be altered, as the correction pattern is essentially a “flat” data collection.

In light of the above discussion, it would be desirable to arrive at some way of correcting for optical proximity effects that may reduce the amount of data required to generate a correction pattern. It would also be desirable to reduce the amount of data that is processed when an original pattern is changed, and a correction pattern must be changed in response.

### SUMMARY OF THE INVENTION

According to aspects of the present invention, an optical proximity effect correcting method may form a “dummy” pattern (referred to herein as a correction pattern) with a computer aided design (CAD) tool. Unlike many conventional approaches, a correction pattern may be formed according to the invention for a block unit of semiconductor device layer, rather than an entire layer. A semiconductor device layer may be for an array, or the like. It is understood that an array may include not only memory cell units, but also additional structures including but not limited to sense amplifier units and/or decoder units.

In addition, by making a correction pattern in a hierarchical structure the design data quantity, and the amount of data that is processed may be reduced.

According to specific embodiments, a method for forming a correction pattern of a photolithography mask with a CAD tool may include various steps. First, a mask data for a semiconductor device may be prepared. Such mask data may be verified. Second, combined data may be created that includes blocks of mask data, with such blocks retaining the same positional relationship as in the mask data. Correction data may be generated for one of the blocks, while the other blocks may be adjacent blocks (i.e., blocks adjacent to the one block). Third, a correction pattern may be formed for the combined data with a CAD tool. Fourth, the correction pattern may be formed into a correction data cell and mounted to an upper layer of the mask data.

According to another aspect of the embodiments, a method of forming a correction pattern for a photolithography photomask with a CAD tool may include: (a) preparing original mask data for an array, where such original array mask data may be verified; (b) creating combined data for multiple blocks, where blocks may correspond to portions of the original mask data and have the same positional relationship as in the array, and blocks of the combined data may include a target block and one or more adjacent blocks; (c) forming a correction pattern for the combined data with a CAD tool; (d) forming the correction pattern into a correction data cell that is mounted on an upper layer of the original mask data corresponding to the target block. Steps (b) to (c) may be repeated for each different combination of the target block and adjacent block(s).

According to one aspect of the embodiments, a block may include one unit selected from the group consisting of a memory cell unit, decoder unit, or array cross unit.

According to another aspect of the embodiments, a method for forming a correction pattern for a photolithography photomask with a CAD tool may include preparing verified original mask data for at least one layer of a semiconductor device. Combined data may be created for blocks of the original mask data. Blocks of combined data can have the same positional relationship as in the original mask data. Further, such blocks may include one block for forming a correction pattern as well as one or more adjacent blocks. A correction pattern may then be formed for the combined data with a CAD tool. Such a correction pattern may have a hierarchical structure. A correction pattern may then be formed into a correction data cell and mounted to an upper layer of original mask data for an entire layer of a semiconductor device.

According to aspects of the embodiments, once a correction pattern has been formed, pattern portions may be removed that do not correspond to the one block, or target block. Such a step may be performed by a CAD tool when the one block (or target block) does not overlap any adjacent blocks. Conversely, such a step may be performed manually when the one block (or target block) overlaps an adjacent block.

### BRIEF DESCRIPTION OF THE DRAWINGS

FIG. 1 is a flow chart illustrating one embodiment of the present invention.

FIGS. 2A and 2B are top plan views showing one example of cut-out data according to an embodiment.

FIG. 3 is a perspective view of a semiconductor device pattern.

FIG. 4 is a diagram showing a correction pattern formation flow according to an embodiment.

FIG. 5 is a plan view showing an example of overlapping adjacent blocks.

FIG. 6 is a diagram showing a correction pattern for an entire array according to a first embodiment.

FIG. 7 is a top plan view of a correction pattern arranged into blocks according to an embodiment.

FIG. 8 is a diagram showing a correction pattern for an entire array according to a second embodiment.

FIG. 9 is a top plan view of a conventional correction pattern.

FIG. 10 is a diagram showing a conventional correction pattern

### DETAILED DESCRIPTION OF THE EMBODIMENTS

The present invention will now be described in one or more detailed embodiments, and with reference to a number of drawings.

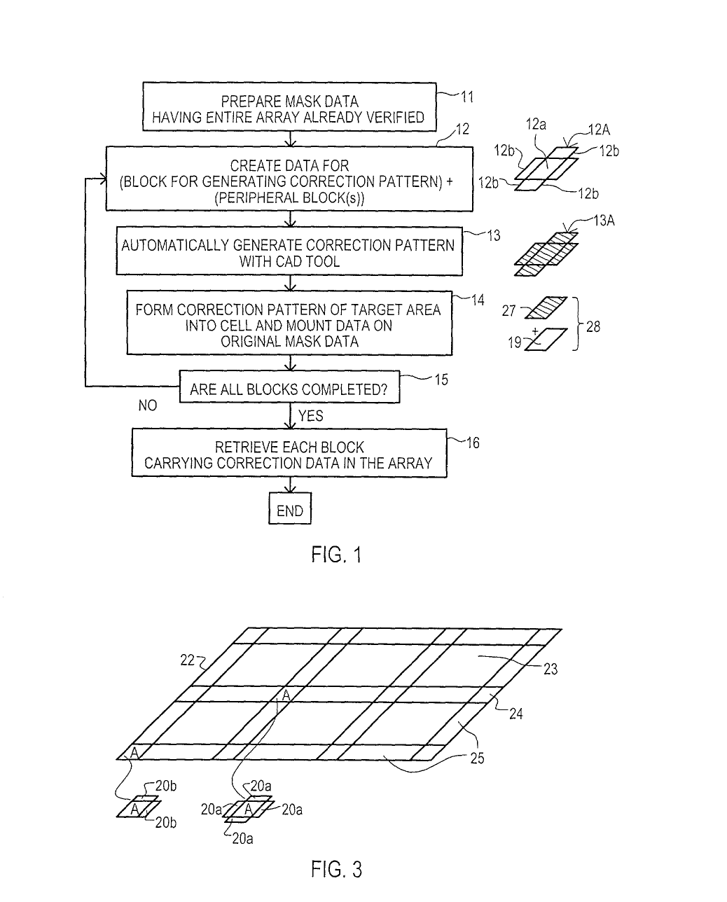

Referring to FIG. 1, a flow chart is set forth that shows various steps of a method for correcting for proximity effects according to a first embodiment.

First, mask data may be prepared for an entire array. Such mask data may be completed for verification by assorted design tools (step 11). Such a step may be performed because a width and space of a design pattern (hereinafter referred to as an original pattern) may necessitate the formation of a corresponding correction pattern. A correction pattern can be created based on original pattern data.

It is desirable that such original pattern data be verified, as such a step is typically a last stage step in a photomask design process. One skilled in the art would recognize that verification may include a design rule check (DRC) and/or layout versus schematic (LVS) check, as but two of the many possible examples.

Next, as shown in FIG. 1, data may be created for a block for generating a correction pattern plus a peripheral block (step 12). Such a step 12 may include creating “cut out” data. An example of cut out data is shown as item 12A in FIG. 1. Cut out data 12A may include a block 12a for forming a correction pattern from an entire array (a target block). In addition, adjacent blocks 12b are also included in the same position relation as original patterns.

In this way, according to the present invention, when a correction pattern for an entire array includes a relatively large amount of data, a correction pattern may be formed on each block unit (such as 12a) basis, as opposed to the entire array.

In addition, according to the present invention, cut out data may further include adjacent blocks 12b. Such blocks may be included in the formation of a correction pattern for a target block, as an adjacent pattern may exert a significant influence in the formation of correction pattern.

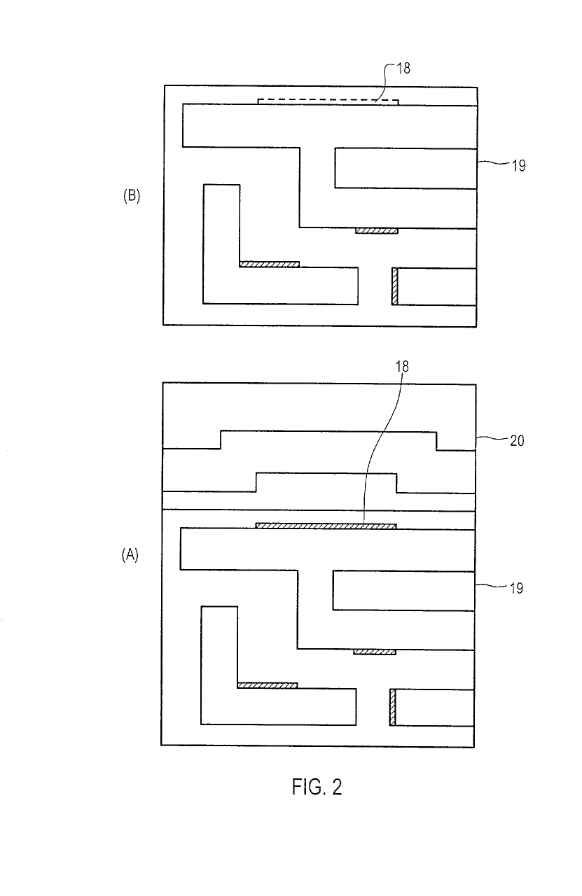

One particular example of combining adjacent blocks is illustrated in FIGS. 2A and 2B. FIG. 2A shows a combined data pattern that may be generated for a target block 19 and an adjacent block 20. In contrast, FIG. 2B shows a data pattern generated from only a target block 19.

As shown in FIG. 2A, a combined data pattern may take into account an influence from an adjacent pattern. In particular, in FIG. 2A, when block 19 is combined with adjacent block 20, a correction pattern 18 (shown with hatching) may result.

In contrast, the reference is made to FIG. 2B, when data for only block 19 is generated (i.e., not in combination with adjacent block 20), adjacent block 20 does not influence a resulting pattern. Consequently, a correction pattern (shown as 18 in FIG. 2A) is not generated (and hence represented by a dashed line).

As would be apparent from the above example, failure to account for an adjacent pattern may result in a corrected pattern that may not include optimal correction features. Thus, according the present invention, a correction pattern for one block (e.g., a target block 19) is carried out by combining a block with one or more adjacent blocks (e.g., block 20).

It is noted that when an adjacent block is combined with a target block, even if a pattern includes a number of identical blocks, a correction pattern may vary when adjacent blocks are different to the original pattern block. Such a variation in pattern is shown by example in FIG. 3.

Referring now to FIG. 3, a perspective view of a semiconductor device pattern is shown. Such a perspective view may illustrate an array, for example. An array 22 may include a memory cell unit 23, a cross unit 24, and a decoder unit 25. A cross unit 24 may exist at the intersections of other units in an array 22.

It will be assumed, for purposes of this discussion, that an array 22 may include identical blocks A. As shown in FIG. 3, one block A may be in a central portion of an array while another block A may be situated at a corner of an array 22. In such an arrangement, a block A in a central portion of an array may be surrounded by four blocks 20a. However, a block A situated in a corner may have only two adjacent blocks 20b.

As would be understood from the previous discussion, while blocks A of FIG. 3 may be identical, a resulting correction pattern for the blocks A could be different, as a central block A would be influenced on four sides by adjacent blocks 20a, while a corner block A would be influenced on two sides by adjacent blocks 20b. Looked at in another way, in such an arrangement it may be necessary to form a number of correction patterns based upon the number of combinations of adjacent blocks.

Referring back to FIG. 1, having created data for a block that includes any adjacent block(s), a correction pattern for such a block may be automatically created using a CAD tool (step 13). Such a correction pattern is shown as 13A in FIG. 1. As shown, such a correction pattern may include portions corresponding to a target block as well as adjacent blocks (shown as 12b).

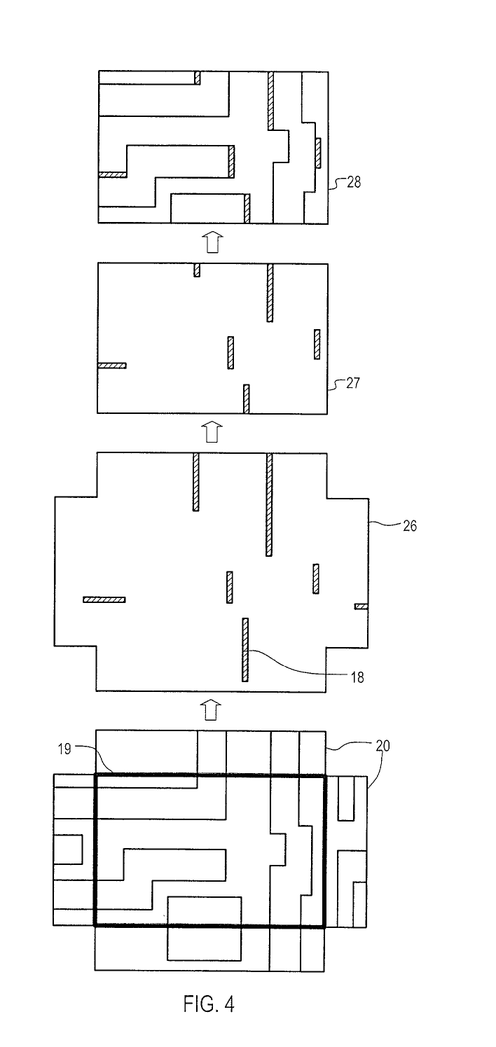

Referring now to FIG. 4 a diagram is set forth showing a correction pattern formation flow according to an embodiment. The flow of FIG. 4 begins at the bottom of the diagram and proceeds towards the top of the diagram. Four flow positions are shown.

A first position (bottom-most) shows a target block 19 that has been combined with adjacent blocks (two of which are shown as 20). A target block 19 is delineated by a bold line.

A second position (second from bottom) shows correction data 26. Such correction data may include correction patterns corresponding to adjacent blocks 20. Further, in the example of FIG. 4, a correction data feature 18 includes a portion that spans both a target block 19 and an adjacent block 20.

A third position (third from bottom) shows a correction data 27 obtained for only a target block 19. In obtaining such a correction pattern, portions of any correction pattern that extend beyond a target block 19 area can be removed. Such a step may prevent such correction data from undesirably extending into an adjacent block. Any correction patterns extending outside a target block area 19 may be cut based on a peripheral frame for the target block 19 area. Accordingly, in the example of FIG. 4, portions of a correction data feature 18 that extend outside a target block 19 area are removed.

In this way, correction data 27 may be obtained for a target block 19 that includes portions of a correction data (such as feature 18) that may be necessary for correcting a target block 19 pattern.

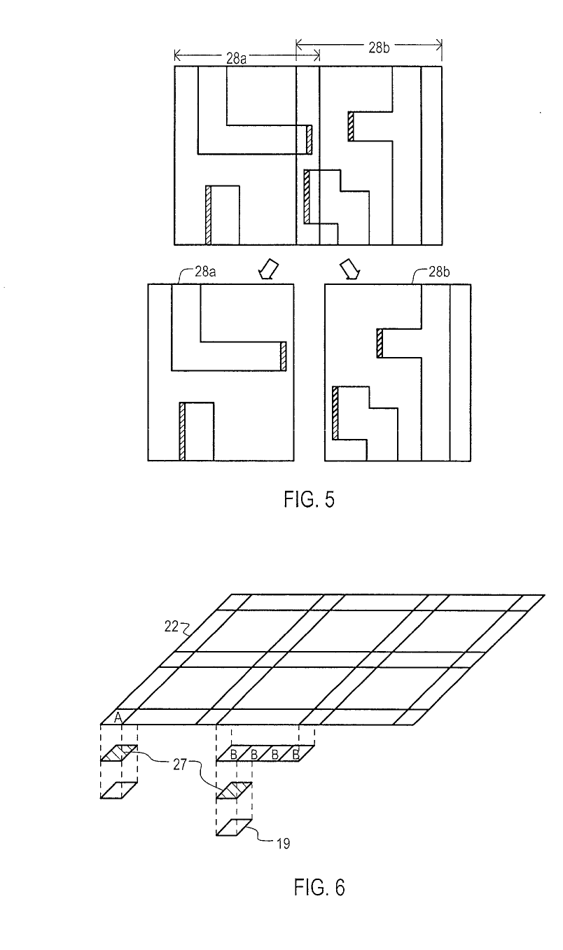

It is noted that there may be cases in which blocks may include overlapping portions instead of simply adjacent sides. Such a case is shown in FIG. 5. The upper portion of FIG. 5 shows blocks 28a and 28b that overlap one another. Due to such an overlap, it may be difficult to cut out any correction pattern in the area. Thus, in such a case removal of correction patterns from each block may be carried out in a conventional fashion. Resulting blocks 28a and 28b are shown in a lower portion of FIG. 5.

Of course, if adjacent blocks do not overlap, automatic processing may be executed with a CAD tool. In such a case, a correction pattern for an entire layer (like that shown as 40 in FIG. 10) may be formed in a hierarchical structure, such as that represented in FIG. 6. FIG. 6 will be described in more detail below.

Referring once again to FIG. 1, an embodiment may continue by forming correction data into a cell, and loading such data on an upper layer of an original pattern, and thus forming a fully corrected pattern (step 14). Such a step is represented in FIG. 1 by correction data 27 being loaded onto a target area 19 to form correction pattern 28. An even more particular example is shown in FIG. 4.

A fourth position (top most) of the flow in FIG. 4 shows a correction pattern 28 obtained by loading correction data 27 onto an original target block 19. Correction data features are represented by hatching.

The foregoing steps of creating correction data (i.e., steps 12 to 14) may be executed for all blocks by a number of times equal to the combinations of adjacent blocks (step 15).

After correction data has been generated for all blocks (a YES answer to conditional step 15), each block that includes correction data may be fetched for an entire array (step 16). Corrected mask data for an entire array may thus be generated.

Referring to FIG. 6, a representation of a correction pattern for an array according to an embodiment is set forth. As shown by FIG. 6, a hierarchical structure may be formed. Correction data 27 may be loaded onto an upper layer of each block (one of which is shown as 19). A resulting correction pattern may thus be created for an entire array 22.

An optical proximity effect correcting method according to the above embodiment may have a number of advantages.

A first advantage can be a reduction in the quantity of data that is processed to create a corrected pattern. When a correction pattern is formed in a conventional fashion, such as that shown in FIG. 10, correction data for an entire array may be one “flat” layer, resulting in a relatively large amount of data. For example, a memory array of 32 megabits may result in correction data of about 2 gigabytes.

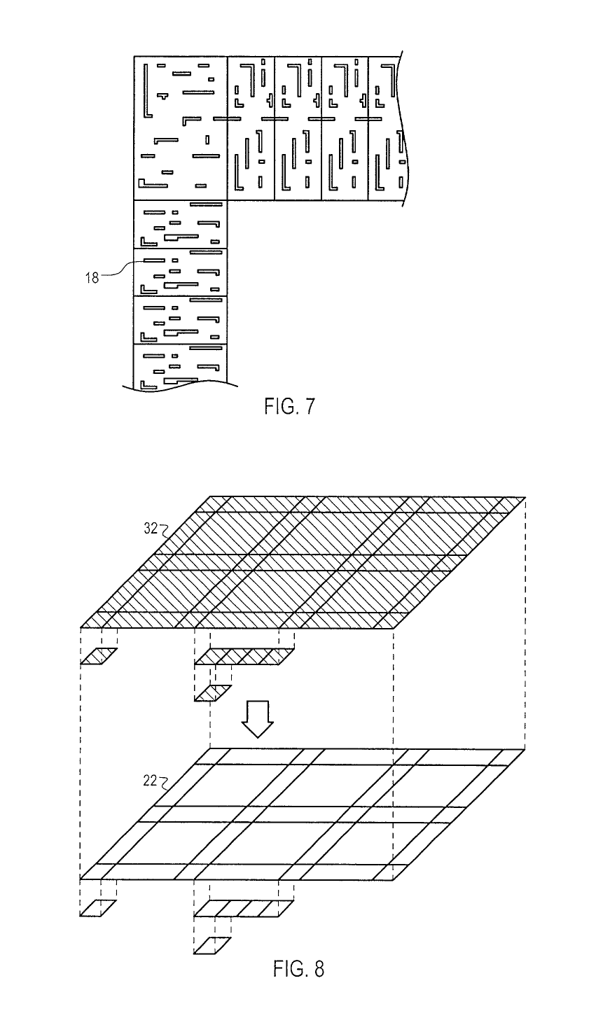

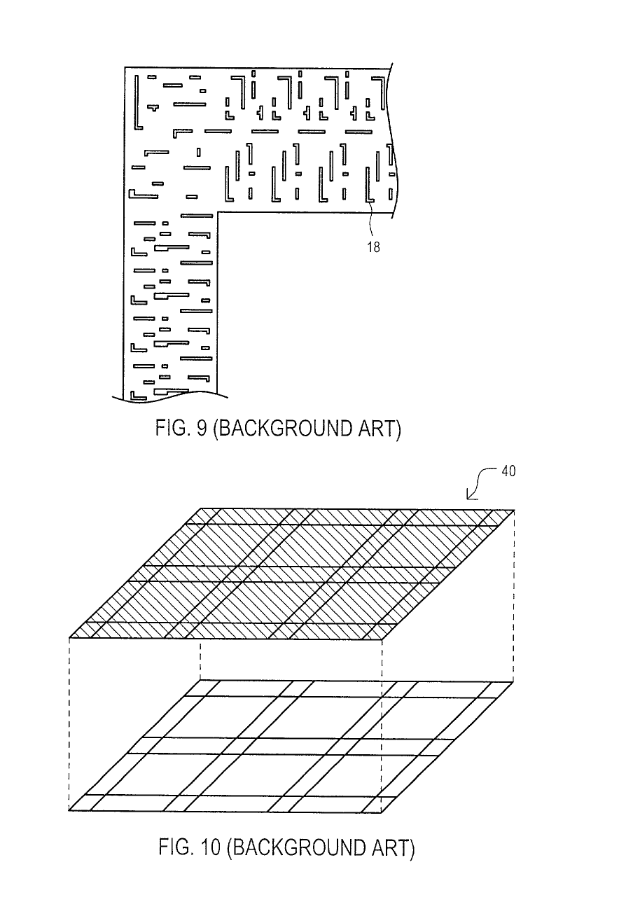

In contrast, in an optical proximity effect correction method according to an embodiment a correction pattern may be formed into a cell for each block (as shown in FIG. 7 and in contrast to conventional FIG. 9). The quantity of data for a 32 megabit array may be about 40 megabytes. Consequently, according to the present invention, correction data may be reduced to about ⅕ that of a conventional case.

A second advantage can be facilitation in pattern correction.

In a conventional case, if a movement occurs in an original pattern, corresponding changes to a conventional correction pattern (such as that shown In FIG. 9) may not be practical. A large amount of data may have to be shifted, as the data is a single “flat” layer.

In contrast, according to the above embodiment, if an array includes identical blocks, the correction of a single block in response to such a change may be all that is required to account for a move. Thus, changes to a correction pattern caused by changes in an original pattern may be more easily facilitated over conventional approaches. This may result in increased design efficiency.

FIG. 8 is a representation of a data structure according to a second embodiment. Such a data structure may be constructed by an optical proximity effect correcting method of the present invention.

In a first embodiment shown in FIG. 6, a correction pattern 27 may be loaded onto an upper layer of an original pattern 19 for each block. In a second embodiment of FIG. 8, unlike FIG. 6, a correction pattern structure may be similar to the hierarchical array structure. In such an arrangement, it can be possible to load correction data for an entire array 32 onto original data 22 for an array.

A second embodiment, like that described above, may facilitate the deletion of correction data when one correction pattern is replaced by another due changes in correction conditions. Thus, design efficiency can be increased.

An optical proximity correction method according to the present invention may provide a number of advantages. First, the quantity of data that may be processed to form a correction pattern may be reduced over conventional approaches. In a conventional method, the quantity of data for a correction pattern can be rather large because of the “flat” arrangement of a correction pattern. However, according to the optical proximity correction method of the present invention, the quantity of data may be reduced, as a correction pattern may be formed into a cell for each block of a mask pattern.

Second, rectification of a correction pattern may be facilitated over conventional approaches. For example, if movement of an original pattern occurs, the amount of data to generate a conventional “flat” data pattern can be very large. However, according to the optical proximity effect correction method of the present invention, if an original pattern includes identical blocks arranged in an array, a correction of one block may be sufficient to generate a correction pattern for an entire array. In this way, work efficiency may be increased.

One skilled in the art would recognize that a “mask” and/or “photomask” may include systems that expose a mask to various spectrums of electromagnetic radiation. Thus, such terms should not be construed to any particular wavelength spectrum and can include various optical wavelengths, electron beam sources, and/or x-ray sources, to name but a few.

While the various particular embodiments set forth herein have been described in detail, the present invention could be subject to various changes, substitutions, and alterations without departing from the spirit and scope of the invention. Accordingly, the present invention is intended to be limited only as defined by the appended claims.

What is claimed is:

1. A method for forming a correction pattern for a photomask to photolithograph with a computer assisted design (CAD) tool, comprising the steps of:
preparing original mask data for a semiconductor device for which verification has been completed;
creating combined data of blocks from the mask data, the blocks having the same positional relationship to one another as in the original mask data, a correction being formed for one block, any other blocks being adjacent to the one block;
forming a correction pattern for the combined data with the CAD tool; and
mounting a correction data of the correction pattern on the upper layer of the original mask data for the one block.

2. The method of claim 1, wherein:
the semiconductor device includes an array.

3. The method of claim 1, further including the step of:
forming the correction pattern into a cell of correction data.

4. The method of claim 1, further including:
the step of removing any correction pattern data that does not correspond to the one block.

5. The method of claim 4, wherein:
for combined data of overlapping blocks, manually removing any correction pattern.

6. The method of claim 1, wherein:
for combined data of non-overlapping blocks, removing any correction pattern data with a CAD tool.

7. A method for forming a correction pattern for a photomask to photolithograph with a computer assisted design (CAD) tool, comprising the steps of:
(a) preparing original mask data for an entire array for which verification has been completed;
(b) creating combined data for multiple blocks having the same positional relationship as in the array, the blocks of the combined data including a target block and at least one adjacent block;
(c) forming a correction pattern for the combined data with the CAD tool;
(d) mounting a correction data of the correction pattern on an upper layer of the original mask data corresponding to the target block; and
(e) repeating steps (b) through (d) for each different combinations of the target block and adjacent blocks.

8. The method of claim 7, further including in step (d):
(f) forming the correction pattern into a correction data cell.

9. The method of claim 7, wherein:
the blocks include at least one block selected from the group consisting of a memory cell unit, a decoder unit, and an array cross unit.

10. The method of claim 7, wherein:
the correction pattern of step (c) is an optical proximity effect correction pattern.

11. The method of claim 7, further including:
(g) removing any correction pattern data from the resulting correction pattern of the combined data that does not correspond to the target block.

12. The method of claim 11, wherein:
step (g) includes manually removing any correction pattern for combined data that includes overlapping data blocks.

13. The method of claim 12, wherein:
step (g) removing, with a CAD tool, any correction pattern data for combined data that does not include overlapping blocks.

14. A method for forming a correction pattern for a photolithography photomask with a computer assisted design (CAD) tool, comprising the steps of:
preparing verified original mask data for at least one layer of a semiconductor device;
creating combined data from blocks of the original mask data without changing a positional relationship between the blocks with respect to the original mask data, one block for forming a correction pattern, any other block of the combined data being an adjacent block;
forming a correction pattern for the combined data with the CAD tool, the correction pattern having a hierarchical structure; and
mounting a correction data of the correction pattern on the original mask data for the entire layer of the semiconductor device.

15. The method of claim 14, further including:
forming the correction pattern into a correction data cell.

16. The method of claim 14, wherein:
the correction pattern corrects for optical proximity effects.

17. The method claim 14, wherein:
the original mask data has a hierarchical structure that includes blocks that are repeated to form original data for the layer; and
the correction pattern hierarchical structure includes correction data corresponding to original mask blocks that may be repeated to form the correction pattern.

18. The method of claim 14, further including the step of:
removing any pattern portions from the correction pattern that do not correspond to the one block.

19. The method of claim 18, wherein:
the step of removing any pattern portions is manually performed when an adjacent data block overlaps the one data block.

20. The method of claim 18, wherein:
the step of removing any pattern portions is performed with a CAD tool when an adjacent data block does not overlap the one block.
